(19) United States
(12) Patent Application Publication
(10) Pub. No.: US 2019/0161617 A1
(43) Pub. Date: May 30, 2019

(54) METHOD FOR PREPARING PHENYLAMINOHYDROXYANTHRAQUINONES

(71) Applicant: LANXESS Deutschland GmbH, Cologne (DE)

(72) Inventors: Hans-Ulrich BORST, Elsdorf (DE); Alexa MASSONG, Cologne (DE); Sabine SCHMAUSER, Leverkusen (DE)

(73) Assignee: LANXESS Deutschland GmbH, Cologne (DE)

(21) Appl. No.: 16/183,804

(22) Filed: Nov. 8, 2018

(30) Foreign Application Priority Data
Nov. 24, 2017 (EP) 17203513.1

(51) Int. Cl. C09B 1/514; C08K 5/18

(52) U.S. Cl. CPC C09B 1/5145; C08K 5/18

(57) ABSTRACT

A method for producing 1,4-diphenylamino-5,8-dihydroxyanthraquinone provides a dye with high colour strength and excellent brilliance for colouring plastics.

The present invention relates to a novel method for preparing 1,4-diphenylamino-5,8-dihydroxyanthraquinones by reacting 1,4-dichloro-5,8-dihydroxyanthraquinone with phenylamines in the presence of specific solvents.

### BACKGROUND OF THE INVENTION

Phenylaminohydroxyanthraquinones represent a valuable class of dyes which are used particularly for colouring thermoplastics, and which are characterized by high light and weather fastness.

The best known representative of this class of dye is Solvent Green 28 (1,4-bis(4-tert-butylphenylamino)-5,8-dihydroxyanthraquinone (CAS No. 4851-50-7, EINECS No. 225-443-9).

A method for preparing phenylaminohydroxyanthraquinones by condensation of phenylamines with chlorohydroxyanthraquinones is known from EP-A 1 074 586. The reaction of chlorohydroxyanthraquinones with the appropriate amines is carried out therein in the presence of specific bases from the series of alkali metal phosphates and using specific inert solvents such as N-methylpyrrolidone, chlorobenzene, 1,2-dichlorobenzene, 1,2,4-trichlorobenzene, xylene, nitrobenzene and phenol. N-methylpyrrolidone and 1,2-dichlorobenzene are described as particularly preferred solvents.

This method affords the phenylaminohydroxyanthraquinones in relatively good yields and the residual contents of amine in the dye is at low levels of below 600 ppm.

However, the colouristic properties of products produced in such a manner no longer correspond to the current performance requirements.

There is therefore an urgent need for preparation processes which afford phenylaminohydroxyanthraquinones having improved colouristic properties. The object of the present invention was therefore to provide an improved method for preparing 1,4-diphenylamino-5,8-dihydroxyanthraquinones.

A novel preparation method has been found which affords 1,4-diphenylamino-5,8-dihydroxyanthraquinones in very good yields, with high purity, and with improved colouristic properties.

### SUMMARY OF THE INVENTION

The present invention relates to a method for preparing compounds of formula (I)

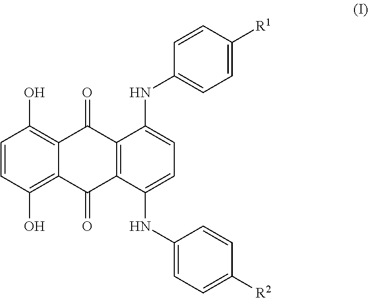

in which R¹ and R² are the same or different and are each independently C₁-C₆-alkyl, by reacting 1,4-dichloro-5,8-dihydroxyanthraquinone of formula (II)

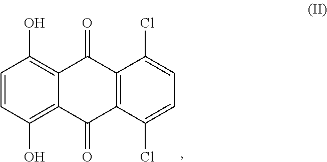 [SMILES: O=C1c2c(O)ccc(O)c2C(=O)c2c(Cl)ccc(Cl)c21]

with at least one of the compounds of formula (IIIa) and/or (IIIb)

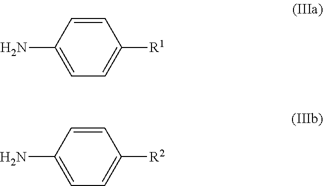

in which R¹ and R² have the definition specified for formula (I), and at least one base, characterized in that the reaction is carried out in the presence of at least one 5- or 6-membered cyclic urea derivative.

### DETAILED DESCRIPTION OF THE INVENTION

The term alkyl is understood to mean, for example, straight-chain or branched C₁-C₆-alkyl, preferably straight-chain or branched C₁-C₄-alkyl, especially methyl, ethyl, n- and isopropyl, and also n-, iso- and tert-butyl. The alkyl radicals specified may be unsubstituted, or mono- or polysubstituted by the same or different substituents. Suitable substituents for the alkyl radicals specified are, for example, halogen such as chlorine, bromine or fluorine, and also hydroxyl, cyano, amino and C₁-C₆-alkoxy.

The term alkoxy is understood to mean, for example, straight-chain or branched C₁-C₆-alkoxy, preferably straight-chain or branched C₁-C₄-alkoxy, especially methoxy, ethoxy, n- and isopropoxy, and also n-, iso- and tert-butoxy. The alkoxy radicals specified may be unsubstituted, or mono- or polysubstituted by the same or different substituents. Suitable substituents for the alkoxy radicals specified are, for example, halogen such as chlorine, bromine or fluorine, and also hydroxyl, cyano, amino and C₁-C₆-alkoxy.

Preferably, the method according to the invention serves for the preparation of compounds of formula (I), in which R¹ and R² are the same or different and are each independently C₁-C₄-alkyl, especially methyl, ethyl, n- and isopropyl, and also n-iso- and tert-butyl.

In particular, the method according to the invention serves for the preparation of compounds of formula (I), in which R¹ and R² are the same or different and are each independently C₁-C₄-alkyl, especially methyl, ethyl, n- and isopropyl, and also n-iso- and tert-butyl.

Very particularly preferably, the method according to the invention serves for the preparation of compounds of formula (I), in which R¹ and R² are the same or different and are each independently n-, iso- and tert-butyl.

In an alternative embodiment, the method according to the invention serves for the preparation of compounds of formula (I), in which R¹ and R² are identical and have the general and preferred definitions specified for formula (I).

The 1,4-dichloro-5,8-dihydroxyanthraquinone of formula (II) is generally used in pure form for the method according to the invention. However, it is also possible to use this compound as technical-grade material with the same good result. This technical-grade material comprises, in addition to the main constituent 1,4-dichloro-5,8-dihydroxyanthraquinone, in general 15 to 30% of impurities in the form of more highly substituted products and/or products isomeric to the main component.

Preferably, 1,4-dichloro-5,8-dihydroxyanthraquinone in the form of this technical-grade material is used for the method according to the invention. In the reaction according to the invention with the amines of formula (III), the chlorine atoms present in the by-products present in the technical-grade material are also replaced by amino groups. These reaction products however remain in the mother liquor after the reaction according to the invention and can be separated off with this from the compounds of formula (I) according to the invention and therefore are no impairment to the quality of the end product.

1,4-Dichloro-5,8-dihydroxyanthraquinone can be prepared in a yield of about 80% of theory by chlorination of 1,4-dihydroxyanthraquinone in the presence of boric acid and iodine in 30% oleum (cf. O. Bayer, Methoden der Organischen Chemie (Houben-Weyl), 4th Edition 1979, Volume VII/3c, page 121 f). The purity of a technical-grade material produced in such a manner is typically about 80%.

To carry out the method according to the invention, at least one compound of formulae (IIIa) and/or (IIIb) is preferably used in which R¹ and R² are C₁-C₄-alkyl.

Suitable compounds of formulae (IIIa) and (IIIb) are, for example, 4-methylaniline, 4-ethylaniline, 4-n-propylaniline, 4-isopropylaniline, 4-n-butylaniline, 4-isobutylaniline and 4-tert-butylaniline. As compound of formulae (IIIa) and (IIIb), preference is given to using 4-n-butylaniline, 4-isobutylaniline and/or 4-tert-butylaniline, in particular 4-tert-butylaniline is used.

To carry out the method according to the invention, in general one mole of at least one compound of formulae (IIIa) and/or (IIIb) is used, preferably plus an excess of 10 to 50% by weight, particularly preferably 10 to 30% by weight, especially 10 to 20% by weight, based in each case on 1 mol of the total amount of compounds (IIIa) and (IIIb), per mole of 1,4-dichloro-5,8-dihydroxyanthraquinone of formula (II).

The amines of formula (IIIa) and (IIIb) are known commercial products and can be sourced, for example, from Lanxess Deutschland GmbH.

The method according to the invention is carried out in the presence of at least one 5- or 6-membered cyclic urea derivative. Preference is given to the use of one or more cyclic urea derivatives of formula (IV)

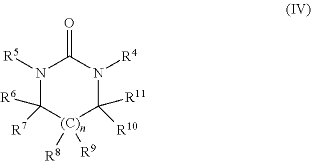

in which
R⁴ and R⁵ are each independently C₁-C₆-alkyl or C₁-C₆-alkoxy,
R⁶ to R¹¹ are each independently hydrogen, C₁-C₆-alkyl or phenyl, and
n is zero or one.

In the case that n=zero, the free carbon valencies form a carbon-carbon single bond to form a five-membered ring.

Particular preference is given to the use of one or more cyclic urea derivatives of formula (IV) in which

R⁴ and R⁵ are each independently unsubstituted C₁-C₄-alkyl or C₁-C₄-alkyl which is mono- or disubstituted by hydroxyl, or is C₁-C₄-alkoxy,
R⁶ to R¹¹ are each independently hydrogen, C₁-C₄-alkyl,
and
n is zero or one.

Particular preference is likewise given to the use of one or more cyclic urea derivatives of formula (IV) in which

R⁴ and R⁵ are each independently unsubstituted C1-C₄-alkyl,
R⁶ to R¹¹ are each independently hydrogen or unsubstituted C₁-C₄-alkyl,
and
n is zero or one.

Very particular preference is given to the use of one or more cyclic urea derivatives of formula (IV) in which

R⁴ and R⁵ are the same and are methyl, ethyl, n-propyl, isopropyl, n-butyl, isobutyl, tert-butyl, hydroxymethyl, hydroxyethyl, methoxy or ethoxy,
R⁶ to R¹¹ are each independently hydrogen or methyl
and
n is zero or one.

Very particular preference is likewise given to the use of one or more cyclic urea derivatives of formula (IV) in which

R⁴ and R⁵ are the same and are methyl, ethyl, n-propyl, isopropyl, n-butyl, isobutyl or tert-butyl,
R⁶ to R¹¹ are each independently hydrogen or methyl
and
n is zero or one.

In particular, preference is given to the use of cyclic urea derivatives from the series of

N,N′-dimethylpropyleneurea (CAS No. 7226-23-5), N,N′-dimethylethyleneurea (CAS No. 80-73-9), N,N′-diethylpropyleneurea (CAS No. 30826-85-8), N,N′-dimethyl-5,5-dimethylpropyleneurea (CAS No. 30879-82-4), N,N′-di(n-propyl)propyleneurea (CAS No. 30826-87-0), N,N′-bis(hydroxymethyl)propyleneurea (CAS No. 3270-74-4), N,N′-bis(hydroxymethyl)ethyleneurea (CAS No. 136-84-5, N,N′-bis(methoxymethyl) ethyleneurea (CAS No. 2669-72-9) and N,N′-di(n-butyl)ethyleneurea (CAS No. 4761-09-5).

It is possible to carry out the method according to the invention in the presence of one or more of the cyclic urea derivatives specified. The cyclic urea derivatives specified can be used here individually or in any desired mixture with one another. Preference is given to carrying out the method according to the invention in the presence of only one of the urea derivatives specified. Particular preference is given to the use of N,N′-dimethylpropyleneurea, N,N′-diethylpropylene urea, N,N′-dimethylethyleneurea and N,N′-di(n-butyl)ethyleneurea.

The cyclic urea derivatives specified are known and can be sourced, for example, from BASF.

To carry out the method according to the invention, in general 10 to 30 mol, preferably 12 to 20 mol of at least one cyclic urea derivative is used per mole of 1,4-dichloro-5,8-dihydroxyanthraquinone of formula (II).

The cyclic urea derivatives used to carry out the method according to the invention serve as solvent for the reaction of 1,4-dichloro-5,8-dihydroxyanthraquinone with the amines of formula (III). It is preferable to carry out the method according to the invention exclusively in the presence of this solvent. To carry out the method according to the invention however, it is possible to use further solvents such as N-methylpyrrolidone, chlorobenzene, 1,2-dichlorobenzene, 1,2,4-trichlorobenzene, xylene, nitrobenzene and phenol or mixtures thereof.

The method according to the invention is carried out in the presence of at least one base. Preferred bases are tripotassium phosphate, trisodium phosphate, dipotassium hydrogenphosphate, disodium hydrogenphosphate, potassium dihydrogenphosphate, sodium dihydrogenphosphate and amines such as triethanolamine and diethanolamine or mixtures thereof.

Particular preference is given to dipotassium hydrogenphosphate and disodium hydrogenphosphate.

To carry out the method according to the invention, in general 0.5 to 2.5 equivalents of base are used, preferably 0.5 to 1 equivalent, per chlorine atom to be exchanged in the compounds of formula (II) or per mole of hydrochloric acid released.

The method according to the invention is generally carried out in a temperature range from 100 to 200° C., preferably 120 to 180° C.

The method according to the invention is generally conducted at ambient pressure. However, it is also possible to carry out the method in a pressure range of 500 to 2000 hPa, preferably 800 to 1200 hPa. Ambient pressure is understood to mean an air pressure in the range from about 925 hPa to 1070 hPa.

The method according to the invention is generally carried out such that at least one of the cyclic urea derivatives that functions as solvent is initially charged, then 1,4-dichloro-5,8-dihydroxyanthraquinone and at least one compound (IIIa) and/or (IIIb) are added and subsequently the base is added. After completion of the reaction, the reaction mixture is worked-up in a customary manner. The work-up is effected in a known manner by precipitating the 1,4-diphenylamino-5,8-dihydroxyanthraquinone of the formula (I) that is formed from the reaction medium. The precipitation can be completed by addition of at least one polar solvent, for example those from the series of alcohols, preferably methanol. The dye of formula (I) can then be isolated in customary fashion, for example by suction filtration through a Nutsche filter or a filter press. For further purification, the isolated dye can be washed with water and/or polar solvents, preferably with water and methanol. Subsequently, the dye is typically dried, preferably at a temperature in the range of 80 to 100° C. and at a pressure in the range of 100 to 130 hPa.

The impurities of undesired by-products remain dissolved in the mother liquor when carrying out the method according to the invention, and are virtually completely removed by displacing the mother liquor during the isolation by means of filtration and washing of the residue.

The method according to the invention affords the compounds of formula (I) in very good yields of 95 to 100%, preferably >95%, the content of amine impurities of formulae (IIIa) and/or (IIIb) being less than 600 ppm, preferably less than 300 ppm.

Preferably, the method according to the invention serves for the preparation of compounds of formula (I) in which R¹ and R² are identical and are each n-butyl, isobutyl or tert-butyl, especially for the preparation of 1,4-bis(4-tert-butylphenylamino)-5,8-dihydroxyanthraquinone (Solvent Green 28, CAS No. 4851-50-7, EINECS No. 225-443-9).

The compounds of formula (I) are valuable dyes for the transparent and muted colouring of plastics such as polystyrene, polyamide, polycarbonate (PC), polyethylene, polyesters, e.g. polyethylene terephtalate (PET) or polyethylene butylate and also polymethyl methacrylate (PMMA), acrylonitrile-butadiene-styrene copolymers (ABS) and ABS-PC blends. They can be used both for bulk colouration and for spin colouration of the plastics mentioned.

The present invention further relates to the use of the compounds of formula (I) prepared by the method according to the invention (I), especially to 1,4-bis(4-tert-butylphenylamino)-5,8-dihydroxyanthraquinone thus prepared for colouring plastics in bulk.

Bulk colouration in this case is understood to mean in particular methods in which the dye is incorporated into the molten plastic material, e.g. with the aid of an extruder, or in which the dye is already added to the starting components for preparing the plastic, e.g. to monomers prior to polymerization.

Particularly preferred plastics are polystyrene, polyamide, polycarbonate (PC), polyethylene, polyesters, e.g. polyethylene terephtalate (PET) or polyethylene butylate and also polymethyl methacrylate (PMMA), acrylonitrile-butadiene-styrene copolymers (ABS) and ABS-PC blends.

Surprisingly, the compounds of formula (I) prepared by the method according to the invention, especially 1,4-bis(4-tert-butylphenylamino)-5,8-dihydroxyanthraquinone prepared according to the invention, are characterized by improved colour brilliance and improved colour strength.

The present invention furthermore provides 1,4-bis(4-tert-butylphenylamino)-5,8-dihydroxyanthraquinone (Solvent Green 28), having a brilliance of 0.3 to 0.8 dC, preferably 0.4 to 0.7 dC, measured in accordance with DIN EN ISO 11664-4, and/or a colour strength of 100 to 110%, preferably 105 to 109%, measured in accordance with DIN 55986 and DIN EN ISO 11664-4.

The following examples are intended to illustrate the present invention but shall not be restricted thereto. All percentages refer to weight unless stated otherwise.

### EXAMPLES

### Example 1

Preparation of 1,4-bis(4-tert-butylphenylamino)-5,8-dihydroxyanthraquinone (in Analogy to EP-A 1 074 586, Non-Inventive)

100 g (1010 mmol) of N-methylpyrrolidone were initially charged in a glass reactor under passing nitrogen and heated to 70° C. 20 g (134 mmol) of p-tert-butylaniline were then added. Subsequently, 17 g (44 mmol) of 5,8-dichloro-1,4-dihydroxyanthraquinone (technical-grade, 80%) and 15.7 g (110.5 mmol) of disodium hydrogenphosphate were added and the reaction mixture was heated to 150° C. The reaction mixture was stirred at this temperature for 3 hours and then heated to 180° C. and stirred at this temperature for a further 10 hours. After completion of the reaction, the reaction mixture was cooled to 100° C. and 30 g of methanol were added. This mixture was stirred at 80° C. for one hour. After cooling to 50° C., the mixture was filtered through a Nutsche filter. The filter cake was firstly washed with 450 g of warm methanol and then with 1500 ml of warm water. The isolated and washed product was then dried in a vacuum drying cabinet at 70° C. and 150 hPa.

Yield 22 g (93.5% of theory)

### Example 2

Preparation of 1,4-bis(4-tert-butylphenylamino)-5,8-dihydroxyanthraquinone (in Analogy to EP-A 1 074 586, Non-Inventive)

The reaction and work-up was carried out exactly as in example 1, but 100 g of N-methylpyrrolidone were replaced by 100 g (680 mmol) of 1,2-dichlorobenzene.

Yield 23 g (98% of theory)

### Example 3

Preparation of 1,4-bis(4-tert-butylphenylamino)-5,8-dihydroxyanthraquinone (in Analogy to EP-A 1 074 586, Non-Inventive)

The reaction and work-up was carried out exactly as specified in example 1, but 100 g of N-methylpyrrolidone were replaced by 100 g (551 mmol) of 1,2,4-trichlorobenzene.

Yield 22.6 g (96.1% of theory)

### Example 4

Preparation of 1,4-bis(4-tert-butylphenylamino)-5,8-dihydroxyanthraquinone (in Analogy to EP-A 1 074 586, Non-Inventive)

The reaction and work-up was carried out exactly as in example 1, but 100 g of N-methylpyrrolidone were replaced by 100 g (813 mmol) of nitrobenzene.

Yield 22.2 g (94.7% of theory)

### Example 5

Preparation of 1,4-bis(4-tert-butylphenylamino)-5,8-dihydroxyanthraquinone (Inventive)

The reaction and work-up was carried out exactly as specified in example 1, but 100 g of N-methylpyrrolidone were replaced by 100 g (781 mmol) of N,N′-dimethylpropyleneurea.

Yield 23.1 g (98.5% of theory)

### Example 6

Preparation of 1,4-bis(4-tert-butylphenylamino)-5,8-dihydroxyanthraquinone (Inventive)

The reaction and work-up was carried out exactly as specified in example 1, but 100 g of N-methylpyrrolidone were replaced by 100 g (877 mmol) of N,N′-dimethylethyleneurea.

Yield 23 g (98% of theory)

### Example 7

Preparation of 1,4-bis(4-tert-butylphenylamino)-5,8-dihydroxyanthraquinone (Inventive)

The reaction and work-up was carried out exactly as specified in example 1, but 100 g of N-methylpyrrolidone were replaced by 100 g (515 mmol) of N,N′-di(n-butyl)ethyleneurea.

Yield 22.8 g (97% of theory)

### Example 8

Preparation of 1,4-bis(4-tert-butylphenylamino)-5,8-dihydroxyanthraquinone (Inventive)

The reaction and work-up was carried out exactly as specified in example 1, but 100 g of N-methylpyrrolidone were replaced by 100 g (658 mmol) of N,N′-diethylpropyleneurea.

Yield 22.9 g (97.5% of theory)

### Example 9

Preparation of 1,4-bis(4-tert-butylphenylamino)-5,8-dihydroxyanthraquinone (Inventive)

The reaction and work-up was carried out exactly as specified in example 1, but 100 g of N-methylpyrrolidone were replaced by 100 g (781 mmol) of N,N′-dimethylpropyleneurea and 15.7 g of disodium hydrogenphosphate were replaced by 19.2 g (110 mmol) of dipotassium hydrogenphosphate.

Yield 23.1 g (98.5% of theory)

### Example 10

Preparation of 1,4-bis(4-tert-butylphenylamino)-5,8-dihydroxyanthraquinone (Inventive)

The reaction and work-up was carried out exactly as specified in example 1, but 100 g of N-methylpyrrolidone were replaced by 100 g (877 mmol) of N,N′-dimethylethyleneurea and 15.7 g of disodium hydrogenphosphate were replaced by 19.2 g (110 mmol) of dipotassium hydrogenphosphate.

Yield 22.9 g (97.5% of theory)

### Example 11

Preparation of 1,4-bis(4-tert-butylphenylamino)-5,8-dihydroxyanthraquinone (Inventive)

The reaction and work-up was carried out exactly as specified in example 1, but 100 g of N-methylpyrrolidone were replaced by 100 g (781 mmol) of N,N′-dimethylpropyleneurea and 15.7 g of disodium hydrogenphosphate were replaced by 11.6 g (110 mmol) of diethanolamine.

Yield 23 g (98% of theory)

### Example 12

Preparation of 1,4-bis(4-tert-butylphenylamino)-5,8-dihydroxyanthraquinone (inventive)

The reaction and work-up was carried out exactly as specified in example 1, but 100 g of N-methylpyrrolidone were replaced by 100 g (877 mmol) of N,N′-dimethylethyleneurea and 15.7 g of disodium hydrogenphosphate were replaced by 11.6 g (110 mmol) of diethanolamine.

Yield 22.9 g (97.5% of theory)

### Determination of Colour Strength and Brilliance

To determine the colour strength and brilliance of the inventive and non-inventive samples of examples 1 to 26, each sample was subjected to a colourimetric measurement, in each case compared to the standard dye Macrolex® Grün G (CAS No. 4851-50-7) (commercial product from Lanxess Deutschland GmbH), in accordance with the procedure specified below.

Polystyrene granules coloured with 2 weight percent titanium dioxide were dried in a circulating air drier at 120° C. for 4 hours. 0.5 kg of the granules was mixed with 0.10 weight percent dye powder. The mixture was extruded at a melt temperature of 280° C. using a twin-screw extruder and then further granulated. The coloured granules were dried at 120° C. for 4 hours. From the dried granules, sample plates of 4 cm×6 cm×0.2 cm were prepared on an injection moulding machine at a melt temperature of 240° C., 10 bar dynamic pressure and 60° C. mould temperature.

After not less than ten injection cycles, sample plates were removed for colour measurement and left to stand at room temperature for at least 1 hour.

Using a d/8° spectrophotometer, reflectance measurements were conducted on the sample plates. The colour strength and the residual colour differences was determined in accordance with DIN 55986 and the brilliance determined in accordance with DIN EN ISO 11664-4.

The results of the colourimetric tests for the non-inventive and inventive examples are listed in Table 1.

TABLE 1

| | | Colour | Brilliance |
|---|---|---|---|
| Example | Inventive | strength [%] | [dC] |
| 1 | No | 100 | 0 |
| 2 | No | 94 | −0.4 |
| 3 | No | 95 | −0.3 |
| 4 | No | 96 | −0.4 |
| 5 | Yes | 109 | 0.8 |
| 6 | Yes | 107 | 0.7 |
| 7 | Yes | 105 | 0.5 |
| 8 | Yes | 105 | 0.4 |
| 9 | Yes | 107 | 0.6 |
| 10 | Yes | 106 | 0.6 |
| 11 | Yes | 107 | 0.7 |
| 12 | Yes | 105 | 0.5 |

### CONCLUSION

The compounds of examples 5 to 12 prepared in accordance with the invention have consistently higher colour strengths and higher brilliance in comparison to the non-inventive prepared compounds of examples 1 to 4.

Colour strength and brilliance are essential dye properties which are of significance with regard to its performance suitability. The higher the colour strength of a sample, the less dye has to be used for colouring. The higher the colour brilliance of a sample, the more colourful is the colouring perceived.

What is claimed is:

1. A method for preparing compounds of formula (I) 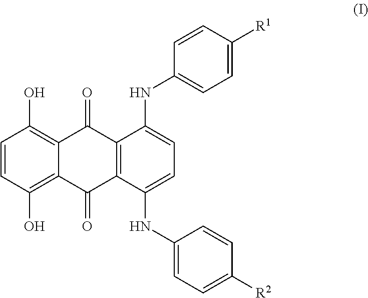
in which R¹ and R² are each independently C₁-C₆-alkyl, the method comprising contacting 1,4-dichloro-5,8-dihydroxyanthraquinone of formula (II) 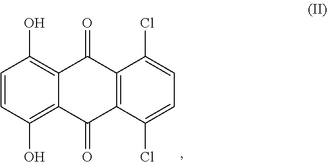 [SMILES: O=C1c2c(O)ccc(O)c2C(=O)c2c(Cl)ccc(Cl)c21]
with:
at least one of the compounds of formulae (IIIa) and (IIIb) 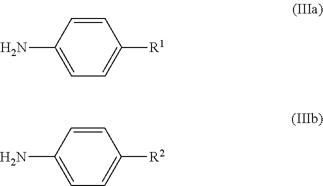
in which R¹ and R² have the definition specified for formula (I), and at least one base,
in the presence of at least one 5- or 6-membered cyclic urea derivative.

2. The method of claim 1, wherein the 5- or 6-membered cyclic urea derivatives are those of formula (IV) 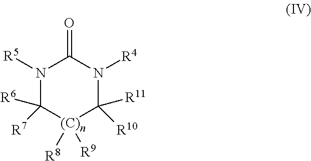
in which
R⁴ and R⁵ are each independently C₁-C₆-alkyl or C₁-C₆-alkoxy,
R⁶ to R¹¹ are each independently hydrogen, C₁-C₆-alkyl or phenyl, and
n is zero or one.

3. The method of claim 2, wherein in formula (IV):
R⁴ and R⁵ are each independently unsubstituted C₁-C₄-alkyl or C₁-C₄-alkyl which is mono- or disubstituted by hydroxyl, or is C₁-C₄-alkoxy,
R⁶ to R¹¹ are each independently hydrogen or C₁-C₄-alkyl, and
n is zero or one.

4. The method of claim 2, wherein in formula (IV):
R⁴ and R⁵ are the same and are methyl, ethyl, n-propyl, isopropyl, n-butyl, isobutyl, tert-butyl, hydroxymethyl, hydroxyethyl, methoxy or ethoxy,
R⁶ to R¹¹ are each independently hydrogen or methyl, and
n is zero or one.

5. The method of claim 1, further comprising using 10 to 30 mol of the at least one 5- or 6-membered cyclic urea derivative per mole of 1,4-dichloro-5,8-dihydroxyanthraquinone of formula (II).

6. The method of claim 1, wherein each compound of formula (IIIa) or (IIIb) is at least one of 4-n-butylaniline, 4-isobutylaniline, or 4-tert-butylaniline.

7. The method of claim 1, wherein, in total, one mole of at least one of the compounds of formulae (IIIa) and/or (IIIb) is used per mole of 1,4-dichloro-5,8-dihydroxyanthraquinone of formula (II).

8. The method of claim 1, wherein the base is selected from the series tripotassium phosphate, trisodium phosphate, dipotassium hydrogenphosphate, disodium uydrogenphosphate, potassium dihydrogenphosphate, sodium dihydrogenphosphate, triethanolamine and diethanolamine.

9. The method of claim 1, wherein the contacting is at a temperature of 100 to 200° C.

10. The method of claim 1, wherein the contacting is at a pressure of 500 to 2000 hPa.

11. 1,4-Bis(4-tert-butylphenylamino)-5,8-dihydroxyanthraquinone (Solvent Green 28) having a brilliance of 0.3 to 0.8 dC measured in accordance with DIN EN ISO 11664-4, and/or a colour strength of 100 to 110% measured in accordance with DIN 55986 and DIN EN ISO 11664-4.

12. A method for the bulk colouring of plastics, the method comprising incorporating the 1,4-bis(4-tert-butylphenylamino)-5,8-dihydroxyanthraquinone of claim 11 into plastic compositions.

13. The method of claim 1, wherein:
the 5- or 6-membered cyclic urea derivatives are those of formula (IV) 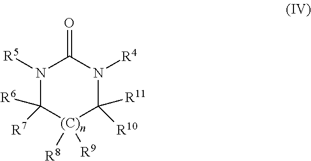
in which
R⁴ and R⁵ are each independently C₁-C₆-alkyl or C₁-C₆-alkoxy,
R⁶ to R¹¹ are each independently hydrogen, C₁-C₆-alkyl or phenyl, and
n is zero or one;
10 to 30 mol of the at least one 5- or 6-membered cyclic urea derivative is used per mole of 1,4-dichloro-5,8-dihydroxyanthraquinone of formula (II);
each compound of formula (IIIa) or (IIIb) is at least one of 4-n-butylaniline, 4-isobutylaniline, or 4-tert-butylaniline;
in total, one mole of the at least one of the compounds of formulae (IIIa) and/or (IIIb) is used per mole of 1,4-dichloro-5,8-dihydroxyanthraquinone of formula (II);
the base is selected from the group consisting of tripotassium phosphate, trisodium phosphate, dipotassium hydrogenphosphate, disodium uydrogenphosphate, potassium dihydrogenphosphate, sodium dihydrogenphosphate, triethanolamine and diethanolamine; and
the contacting is at a temperature of 100 to 200° C. and a pressure of 500 to 2000 hPa.

14. The method of claim 13, wherein in formula (IV):
12 to 20 mol of the at least one cyclic urea derivative is used per mole of 1,4-dichloro-5,8-dihydroxyanthraquinone of formula (II);
R⁴ and R⁵ are the same and are methyl, ethyl, n-propyl, isopropyl, n-butyl, isobutyl, tert-butyl, hydroxymethyl, hydroxyethyl, methoxy or ethoxy,
R⁶ to R¹¹ are each independently hydrogen or methyl, and n is zero or one.

15. The method of claim 14, wherein the cyclic urea derivatives are selected from the group consisting of N,N′-dimethylpropyleneurea, N,N′-dimethylethyleneurea, N,N′-diethylpropyleneurea, N,N′-dimethyl-5,5-dimethylpropyleneurea, N,N′-di(n-propyl)propyleneurea, N,N′-bis(hydroxymethyl)propyleneurea, N,N′-bis(hydroxymethyl)ethyleneurea, N,N′-bis(methoxymethyl) ethyleneurea, and N,N′-di(n-butyl)ethyleneurea, and combinations thereof.

16. The method of claim 15, wherein:
the cyclic urea derivatives are selected from the group consisting of N,N′-dimethylpropyleneurea, N,N′-diethylpropylene urea, N,N′-dimethylethyleneurea and N,N′-di(n-butyl)ethyleneurea, and combinations thereof; and
the base is selected from dipotassium hydrogenphosphate, and disodium hydrogenphosphate. and combinations thereof.

17. The method of claim 16, wherein: 0.5 to 2.5 equivalents of base are used, preferably 0.5 to 1 equivalent, per chlorine atom to be exchanged in the compounds of formula (II) or per mole of hydrochloric acid released; and
the temperature is 120 to 180° C. and the pressure is ambient pressure.

18. The method according to claim 1, further comprising:
placing the at least one 5- or 6-membered cyclic urea derivative, as a solvent, into a reaction vessel;
adding the 1,4-dichloro-5,8-dihydroxyanthraquinone, the at least one compound (IIIa) and/or (IIIb) to the reaction vessel, and the base to the reaction vessel to produce a mixture;
heating the mixture to a temperature of 100 to 200° C. at a pressure of 500 to 2000 hPa for a period of time sufficient to form the 1,4-diphenylamino-5,8-dihydroxyanthraquinone; and
precipitating and isolating the 1,4-diphenylamino-5,8-dihydroxyanthraquinone from the mixture.
